(19) United States
(12) Patent Application Publication
(10) Pub. No.: US 2025/0069345 A1
(43) Pub. Date: Feb. 27, 2025

(54) METHOD FOR GENERATING POINT CLOUD DATA

(71) Applicant: BEIJING BAIDU NETCOM SCIENCE TECHNOLOGY CO., LTD., Beijing (CN)

(72) Inventors: Bo JU, Beijing (CN); Xiaoqing YE, Beijing (CN); Xiao TAN, Beijing (CN); Hao SUN, Beijing (CN)

(21) Appl. No.: 17/917,518

(22) PCT Filed: Apr. 21, 2022
(86) PCT No.: PCT/CN2022/088312

§ 371 Date: Oct. 6, 2022

(30) Foreign Application Priority Data
May 21, 2021 (CN) 202110556351.0

(51) Int. Cl. G06T 19/20; G06T 17/00

(52) U.S. Cl. CPC G06T 19/20; G06T 17/00; G06T 2200/08; G06T 2207/10028; G06T 2207/20221

(57) ABSTRACT

Disclosed are a method for generating point cloud data, an electronic device and a storage medium. The method includes: acquiring a set of real point clouds for a target object based on a LiDAR; performing image acquisition on the target object, and generating a set of pseudo point clouds based on an acquired image; and generating the set of target point clouds for model training by fusing the set of real point clouds and the set of pseudo point clouds.

### CROSS-REFERENCE TO RELATED APPLICATIONS

This application is a U.S. National Stage of International Application No. PCT/CN2022/088312, which is based on and claims priority to Chinese Patent Application No. 202110556351.0, filed on May 21, 2021, the entire contents of which are incorporated herein by reference.

### TECHNICAL FIELD

The present disclosure relates to a field of artificial intelligence (AI), and specifically to a field of computer vision and deep learning (DL), which is applied to autonomous driving and intelligent transportation.

### BACKGROUND

Deep learning technology has made great success in the fields of computer vision and natural language processing in recent years. 3D object detection in a point cloud, as a classic sub-task in the computer vision, has also become a hot topic of deep learning researchers. Typically, the data acquired by a LIDAR is displayed and processed in the form of a point cloud.

### SUMMARY

A method for generating point cloud data, an electronic device and a storage medium are provided in the disclosure.

According to an aspect of the disclosure, a method for generating point cloud data is provided. A set of real point clouds for a target object is acquired based on a LIDAR; image acquisition is performed on the target object, and a set of pseudo point clouds is generated based on an acquired image; and a set of target point clouds for model training is generated by fusing the set of real point clouds and the set of pseudo point clouds. In the disclosure, near and far point clouds in a set of target point clouds for model training are relatively balanced, which may satisfy training requirements better, thus facilitating improving a training precision of a model and monitoring near and far targets.

According to another aspect of the disclosure, an electronic device is provided. The electronic device includes a memory and a processor. The memory stores instructions executable by the at least one processor, in which the instructions are executed by the at least one processor, to implement the method for generating point cloud data as described in the first aspect of the disclosure.

According to another aspect of the disclosure, a non-transitory computer-readable storage medium storing computer instructions is provided in a fourth aspect of the embodiment of the disclosure, in which the computer instructions are configured to implement the method for generating point cloud data as described in the first aspect of the embodiment.

It should be understood that, the content described in the part is not intended to identify key or important features of embodiments of the present disclosure, nor intended to limit the scope of the present disclosure. Other features of the present disclosure will be easy to understand through the following specification.

### BRIEF DESCRIPTION OF THE DRAWINGS

The drawings are intended to better understand the solution, and do not constitute a limitation to the disclosure.

FIG. 1 is a flowchart illustrating a method for generating point cloud data according to an embodiment of the disclosure;

FIG. 2 is a schematic diagram illustrating an RGB image returned by a front camera of an autonomous system according to an embodiment of the disclosure;

FIG. 3 is a schematic diagram illustrating LiDAR sparse point cloud data corresponding to an RGB image according to an embodiment of the disclosure;

FIG. 4 is a schematic diagram illustrating an RGB image returned by a front camera of an autonomous system returns according to an embodiment of the disclosure;

FIG. 5 is a schematic diagram illustrating pseudo LiDAR dense point cloud data corresponding to an RGB image according to an embodiment of the disclosure;

FIG. 6 is a flowchart illustrating a method for acquiring a first point cloud according to an embodiment of the disclosure;

FIG. 7 is a flowchart illustrating a process of generating a set of target point clouds according to an embodiment of the disclosure;

FIG. 8 is a flowchart illustrating a process of generating a set of target point clouds according to an embodiment of the disclosure;

FIG. 9 is a flowchart illustrating a process of acquiring an Euclidean distance between a first point cloud and a set of real point clouds according to an embodiment of the disclosure;

FIG. 10 is a flowchart illustrating a method for generating point cloud data according to an embodiment of the disclosure;

FIG. 11 is a block diagram illustrating an apparatus for generating point cloud data according to an embodiment of the disclosure;

FIG. 12 is a block diagram illustrating an electronic device according to an embodiment of the disclosure.

### DETAILED DESCRIPTION

The exemplary embodiments of the present disclosure are described as below with reference to the accompanying drawings, which include various details of embodiments of the present disclosure to facilitate understanding, and should be considered as merely exemplary. Therefore, those skilled in the art should realize that various changes and modifications may be made to the embodiments described herein without departing from the scope and spirit of the present disclosure. Similarly, for clarity and conciseness, descriptions of well-known functions and structures are omitted in the following descriptions.

Image Processing is a technology that analyzes an image by a computer to achieve a desired result. It is also referred to as photo processing. Image processing generally refers to digital image processing. A digital image refers to a large two-dimensional array obtained from a device such as an industrial camera, a video camera, a scanner, the element of the array is referred to as a pixel, and its value is referred to as a gray value. An image processing technology generally includes image compression, enhancement and restoration, matching, description and recognition.

Deep learning (DL) is a new research direction in the field of Machine Learning (ML), which is introduced into ML so that it is closer to its original goal-artificial intelligence (AI). DL learns inherent law and representation hierarchy of sample data, and information obtained in the learning process is of great help in interpretation of data such as words, images and sound. Its final goal is that the machine may have analytic learning ability like humans, which may recognize data such as words, images, sound, etc. DL is a complicated machine learning algorithm, which has far outperformed the related art in speech and image recognition.

Computer Vision (CV) is a science that studies how to make a machine “look”, further, it means that a camera and a computer replace human eyes to perform machine vision such as recognition, track, and measurement on an object, and further perform graphics processing to process the image into an image more suitable for human eyes or transmit to the instrument for detection by the computer. As a science discipline, CV studies related theory and techniques to attempt to establish an artificial intelligence system that may obtain ‘information’ from images or multidimensional data. The information herein refers to information defined by Shannon that may be configured to assist in making a “decision”. Since perception may be deemed to extract information from a sensory signal, CV may also be regarded as a science that studies how the AI system “perceives” from the image or the multidimensional data.

Artificial intelligence (AI) is a subject that learns simulating certain thinking processes and intelligent behaviors (such as learning, reasoning, thinking, planning, etc.) of human beings by a computer, which covers hardware-level technologies and software-level technologies. AI software technologies generally include computer vision technology, speech recognition technology, natural language processing (NLP) technology and its learning/deep learning (DL), big data processing technology, knowledge graph technology, etc.

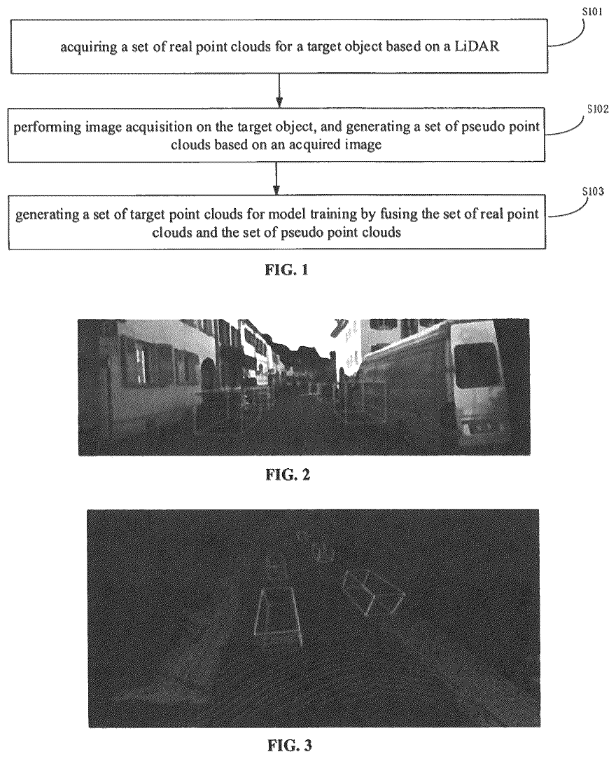

FIG. 1 is a flowchart illustrating a method for generating point cloud data according to an embodiment of the disclosure. As illustrated in FIG. 1, the method for generating point cloud data includes the followings.

At S101, a set of real point clouds for a target object is acquired based on a LiDAR.

A Light Detection and Ranging (LIDAR), also referred to as a laser radar, consists of an emission system, a receiving system and information processing. One hundred thousands, millions or even tens of millions of points (known as a point cloud) may be generated by a LiDAR every second. In simple terms, a point cloud is a number of points scattered in space. Each point contains three-dimensional coordinates (XYZ), laser reflection intensity (Intensity) or color information (Red Green Blue, RGB). A LIDAR emits a laser signal at an object or the ground, acquires a laser signal reflected by the object or the ground, and calculates accurate spatial information of the points through joint calculation and deviation correction. The point cloud data acquired by a LiDAR may be configured in systems for making a digital elevation model, 3D modeling, agricultural and forestry censuses, earthwork calculation, monitoring geological disasters, or autonomous driving.

In some embodiments, for example, the LiDAR is applied in an autonomous system. The LiDAR mounted on an autonomous vehicle may acquire a set of point clouds of an object and ground in front of vision of the autonomous vehicle as a set of real point clouds. The object may be taken as a target object, such as a vehicle, a pedestrian or a tree. As an example, FIG. 2 shows an RGB image returned by a front camera of an autonomous system, and FIG. 3 shows LiDAR sparse point cloud data corresponding to the RGB image. In some embodiments, the front camera may include a front monocular RGB camera or a front binocular RGB camera.

At S102, image acquisition is performed on a target object, and a set of pseudo point clouds is generated based on an acquired image.

In the embodiment of the disclosure, dense pseudo point cloud data may be acquired to assist the LiDAR in collecting point cloud data for a target object.

In some embodiments, pseudo point cloud data may be acquired based on a depth image acquired by an apparatus for acquiring a depth image. In some embodiments, a pixel depth of the acquired depth image is back-projected into a 3D point cloud to obtain the pseudo point cloud data.

In some embodiments, the image acquisition may be performed on the target object based on binocular vision. Two images of an object to be measured may be acquired from different positions based on a parallax principle and using an imaging device, and the pseudo point cloud data may be obtained by calculating a position deviation between corresponding points of the images.

In some embodiments, the image acquisition may be performed on the target object based on monocular vision. A relationship between rotation and translation of the acquired image may be calculated, and the pseudo point cloud data may be obtained based on triangulation calculation of matching points.

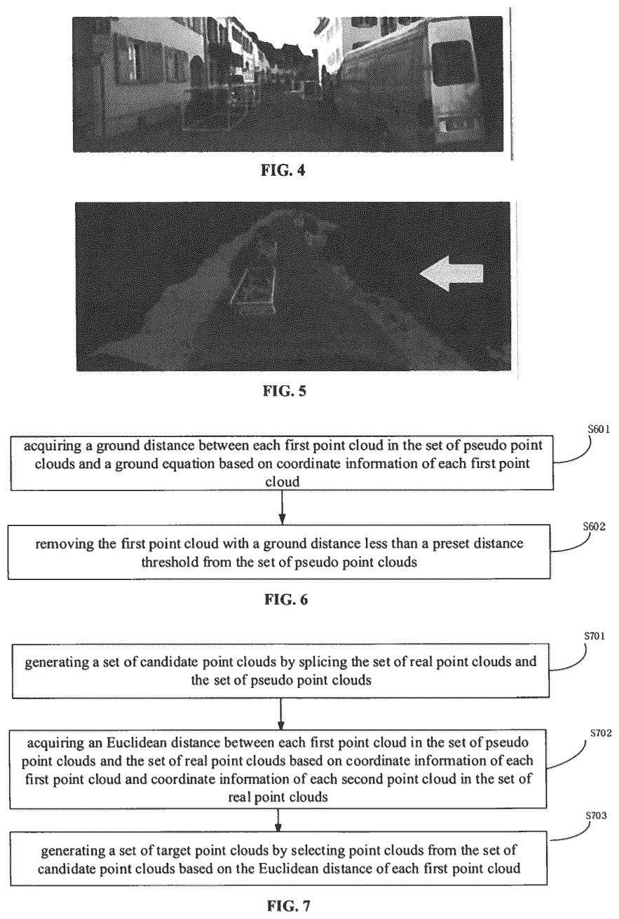

In some embodiments, for example, if applied on an autonomous system, a front monocular RGB camera or a front binocular RGB camera may be configured to acquire a set of point clouds of an object and ground in front of vision of the autonomous vehicle as a set of pseudo point clouds. As an example, FIG. 4 shows an RGB image returned by a front camera of an autonomous system returns, and FIG. 5 shows pseudo LiDAR dense point cloud data corresponding to the RGB image. In some embodiments, the front camera may include a front monocular RGB camera or a front binocular RGB camera.

At S103, a set of target point clouds for model training is generated by fusing the set of real point clouds and the set of pseudo point clouds.

In the point cloud data acquired by a LiDAR, the closer the point cloud is to the LiDAR, the denser the point cloud is, and the farther the point cloud is to the LiDAR, the sparser the point cloud is, which results in a better detection effect near the LiDAR, and a greater attenuation of a detection effect farther away from the LiDAR. In order to avoid the problem, a set of target point clouds is obtained by fusing the set of real point clouds and the set of pseudo point clouds. Since the data amount of the set of pseudo point clouds is relatively large, the set of real point clouds may be supplemented with dense set of pseudo point clouds, so that the near and far point clouds in the set of target point clouds for model training are relatively balanced, which may satisfy training requirements better, thus facilitating providing a training precision of a model and monitoring near and far targets.

The method for generating point cloud data is provided in the embodiment of the disclosure. A set of real point clouds for a target object is acquired based on a LIDAR; image acquisition is performed on the target object, and a set of pseudo point clouds is generated based on an acquired image; and a set of target point clouds for model training is generated by fusing the set of real point clouds and the set of pseudo point clouds. In the disclosure, near and far point clouds in the set of target point clouds for model training are relatively balanced, which may satisfy training requirements better, thus facilitating providing a training precision of a model and monitoring near and far targets.

On the basis of the above embodiment, since the pseudo point cloud has dense data, and the fusion of a large number of pseudo point cloud data may lead to a large computation of model training and affect an accuracy of the model. Before the set of real point clouds and the set of pseudo point clouds are fused, first point clouds in the set of pseudo point clouds needs to be filtered. FIG. 6 is a flowchart illustrating a method for generating point cloud data according to an embodiment of the present disclosure. As illustrated in FIG. 6, before the set of target point clouds for model training is generated by fusing the set of real point clouds and the set of pseudo point clouds, the method includes the followings.

At S601, a ground distance between each first point cloud in the set of pseudo point clouds and a ground equation is acquired based on coordinate information of each first point cloud.

The ground equation is calculated based on all point cloud data in the set of pseudo point clouds. In some embodiments, a method for acquiring the ground equation may be a singular value decomposition (SVD) method. After the ground equation is obtained, each point cloud in the set of pseudo point clouds is taken as a first point cloud, and the ground distance between each first point cloud and the ground equation is acquired based on the coordinate information of each first point cloud.

At S602, the first point cloud with a ground distance less than a preset distance threshold is removed from the set of pseudo point clouds.

In the set of pseudo point clouds, there is a large amount of ground point cloud data and point cloud data closer to the ground, which are invalid for training and detection of a target detection system, but may increase a computation amount of the system. Therefore, a distance threshold is set, and when the ground distance between a first point cloud in the set of pseudo point clouds and the ground equation is less than the distance threshold, the first point cloud is removed from the set of pseudo point clouds. Taking the distance threshold being 10 for an example, the first point cloud with the ground distance between the first point cloud in the set of pseudo point clouds and the ground equation less than 10 is removed from the set of pseudo point clouds.

In the embodiment of the disclosure, the ground point cloud is removed from the set of pseudo point clouds, which reduces massive invalid point cloud data, thereby reducing a computation amount of a target detection model, and increasing robustness and accuracy of the target detection model.

FIG. 7 is a flowchart illustrating a method for generating point cloud data according to an embodiment of the disclosure. On the basis of the above embodiment, as illustrated in FIG. 7, generating the set of target point clouds for model training by fusing the set of real point clouds and the set of pseudo point clouds further includes the followings.

At S701, a set of candidate point clouds is generated by splicing the set of real point clouds and the set of pseudo point clouds.

In order to obtain a more accurate target detection model, the set of real point clouds and the set of pseudo point clouds are spliced to obtain the spliced set of point clouds as the set of candidate point clouds. Splicing of point clouds may be understood as a process of calculating a perfect coordinate transformation, and integrating point cloud data from different perspectives into a specified coordinate system through rigid transformations such as rotation and translation.

As an implementation, a method based on a local feature description may be adopted to splice the set of real point clouds and the set of pseudo point clouds: by extracting neighborhood geometric features of each point cloud in the set of real point clouds and the set of pseudo point clouds, a corresponding relationship between point pairs of the set of real point clouds and the set of pseudo point clouds is quickly determined based on the geometric features, and a transformation matrix is obtained by calculating the relationship. The geometric features of a point cloud are various, and fast point feature histgrams (FPFH) are a common geometric feature.

As another implementation, a precise registration method may be adopted to splice the set of real point clouds and the set of pseudo point clouds: precise registration is to calculate a more precise solution through an iterative closest point (ICP) algorithm by means of a known initial transformation matrix. The ICP algorithm constructs a rotation and translation matrix by calculating a distance between corresponding points in the set of real point clouds and the set of pseudo point clouds, transforms the set of real point clouds through the rotation and translation matrix, and calculates a mean square error of the transformed set of point clouds. When the mean square error satisfies a threshold condition, the algorithm ends. Otherwise, the iteration is repeated until the error meets the threshold condition or an iteration number is satisfied.

At S702, a Euclidean distance between each first point cloud in the set of pseudo point clouds and the set of real point clouds is acquired based on coordinate information of each first point cloud and coordinate information of each second point cloud in the set of real point clouds.

Each point cloud in the set of real point clouds acquired by a LiDAR is taken as a second point cloud, and a coordinate of a center point of the set of real point clouds may be determined based on the coordinate information of all second point clouds. The Euclidean distance between each first point cloud and the coordinate of the center point of the set of real point clouds is calculated based on the coordinate information of each first point cloud in the set of pseudo point clouds and the coordinate of the center point of the set of real point clouds.

At S703, a set of target point clouds is generated by selecting point clouds from the set of candidate point clouds based on the Euclidean distance of each first point cloud.

Since the point cloud data is relatively much in the set of candidate point clouds generated by splicing the set of real point clouds and the set of pseudo point clouds, it may cause a large computation amount. In order to reduce the computation amount, a part of point cloud data in the set of candidate point clouds is removed based on the Euclidean distance between each first point cloud and the coordinate of the center point of the set of real point clouds, and the set of point clouds after the part of point cloud data is removed is taken as the set of target point clouds. In some embodiments, a down-sampling method may be adopted to remove the part of point cloud data from the set of candidate point clouds.

In the embodiment of the disclosure, the set of real point clouds and the set of pseudo point clouds are spliced, an accuracy of a target detection model is increased. The point clouds are selected from the set of candidate point clouds as the set of target point clouds, rather than all point cloud data is adopted, a computation amount is reduced.

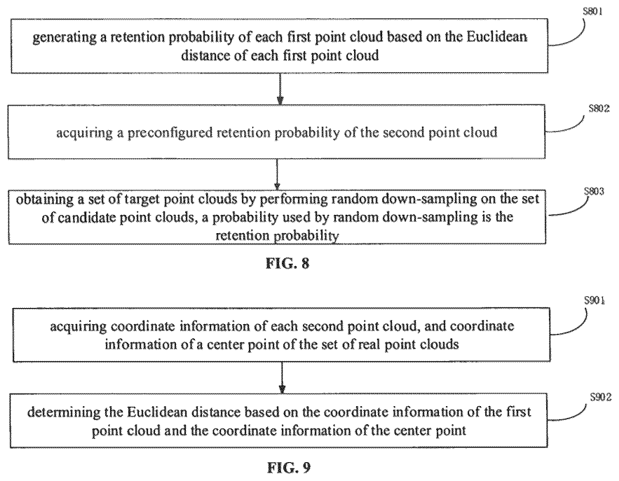

As a possible implementation, FIG. 8 is a flowchart illustrating a process generating the set of target point clouds by selecting point clouds from the set of candidate point clouds based on the Euclidean distance of each first point cloud. As illustrated in FIG. 8, the process includes the followings.

At S801, a retention probability of the first point cloud is generated based on the Euclidean distance of the first point cloud.

Taking autonomous driving for an example, in order to reduce a computation amount, one retention probability may be configured for each first point cloud in the set of pseudo point clouds based on the Euclidean distance between the first point cloud and the set of real point clouds. When the retention probability is configured for each first point cloud, considering that a distant object in the scene has a significant impact on a detection result in the front target detection of autonomous driving, in order to improve detection of a distant object, the larger the Euclidean distance between the first point cloud and the set of real point clouds, the greater the retention probability configured for the first point cloud, and the smaller the Euclidean distance between the first point cloud and the set of real point clouds, the smaller the retention probability configured for the first point cloud. For example, the retention probability configured for the first point cloud with the largest Euclidean distance from the set of real point clouds may be 0.98, and the retention probability configured for the first point cloud configuration with the smallest Euclidean distance from the set of real point clouds may be 0.22.

At S802, a preconfigured retention probability of the second point cloud is acquired.

In order to reduce a computation amount, a retention probability may be configured for each second point cloud in the set of real point clouds acquired by a LiDAR.

In some embodiments, since the second point cloud in the set of real point clouds is sparser than the first point cloud in the set of pseudo point clouds, a retention probability close to or equal to 1 may be uniformly preconfigured for the second point cloud in the set of real point clouds. For example, a retention probability of 0.95 may be uniformly preconfigured for each second point cloud in the set of real point clouds.

At S803, a set of target point clouds is obtained by performing random down-sampling on the set of candidate point clouds, a probability used by random down-sampling is a retention probability.

Since the point cloud data is relatively much in the set of candidate point clouds generate by splicing the set of real point clouds and the set of pseudo point clouds, it may cause a large computation amount. In order to reduce the computation amount, a part of point cloud data in the set of candidate point clouds is removed based on the retention probability of each first point cloud the retention probability of the a second point cloud, and the set of point clouds after the part of point cloud data is removed is taken as the set of target point clouds.

In some embodiments, a random down-sampling method may be adopted to remove the part of point cloud data from the set of candidate point clouds generated by splicing the set of real point clouds and the set of pseudo point clouds, and the probability for the random down-sampling is a retention probability. The random down-sampling is performed on the set of candidate point clouds through the retention probability, so that an effective point cloud representing a target object may be retained, and too many point clouds with the same representative significance gathered at the same position may be removed to the greatest extent, so that the data amount of the near and far point clouds in the set of target point clouds is moderate and may effectively represent the target object.

In the embodiment of the disclosure, the random down-sampling is performed on the set of candidate point clouds based on the retention probability of each first point cloud and the retention probability of the second point cloud, which reduces a computation amount, and the near and far point clouds in the set of target point clouds for model training are relatively balanced, which may satisfy training requirements better.

On the basis of the above embodiment, FIG. 9 is a flowchart illustrating a method for generating point cloud data according to an embodiment of the disclosure. As illustrated in FIG. 9, acquiring the Euclidean distance between each first point cloud in the set of pseudo point clouds and the set of real point clouds based on the coordinate information of each first point cloud and the coordinate information of each second point cloud in the set of real point clouds includes the followings.

At S901, the coordinate information of each second point cloud is acquired, and coordinate information of a center point of the set of real point clouds is acquired.

The coordinate information of each second point cloud in the set of real point clouds is acquired, and the coordinate information of the center point of the set of real point clouds is determined based on the coordinate information of all second point clouds.

In some embodiments, when a coordinate of the center point of the set of real point clouds is acquired, the coordinate information of all second point clouds may be averaged to obtain average coordinate information, and the average coordinate information may be taken as the coordinate information of the center point of the set of real point clouds.

In some embodiments, when the coordinate of the center point of the set of real point clouds is acquired, particle coordinate information of the set of real point clouds may be calculated, and taken as the coordinate information of the center point of the set of real point clouds.

At S902, the Euclidean distance is determined based on the coordinate information of the first point cloud and the coordinate information of the center point.

The Euclidean distance between each first point cloud and the coordinate of the center point is calculated based on the determined coordinate information of the center point of the set of real point clouds.

In the embodiment of the disclosure, the Euclidean distance between a first point cloud and the coordinate of the center point is determined based on the coordinate information of the first point cloud and the coordinate information of the center point, which lays a foundation for configuring a retention probability for the first point cloud, facilitates computation and reduces a computation amount.

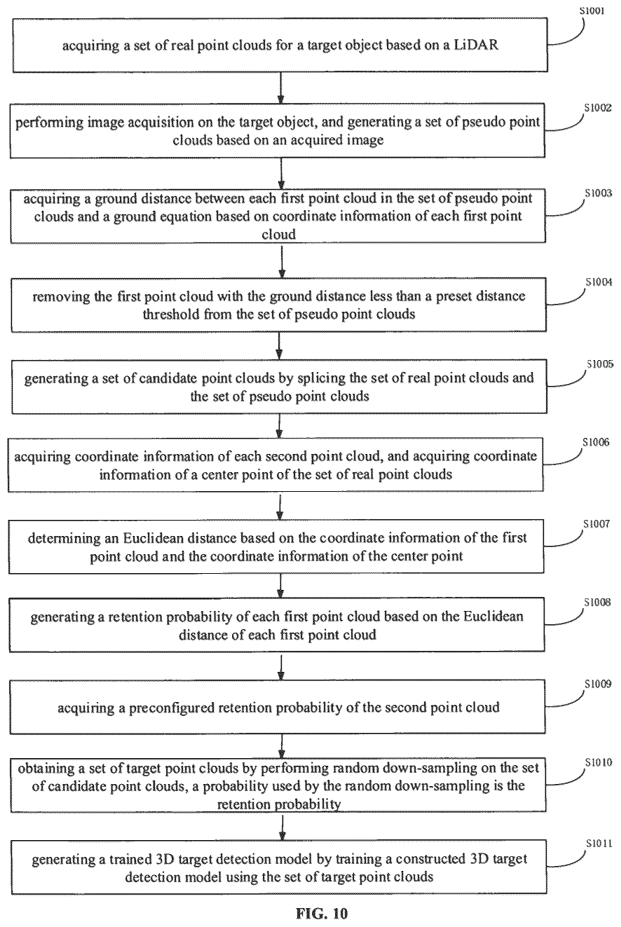

FIG. 10 is a flowchart illustrating a method for generating point cloud data according to an embodiment of the disclosure. As illustrated in FIG. 10, the method for generating point cloud data includes the followings.

At S1001, a set of real point clouds for a target object is acquired based on a LIDAR.

At S1002, image acquisition is performed on the target object, and a set of pseudo point clouds is generated based on an acquired image.

With respect to blocks S1001 to S1002, description has been made in the above embodiments, which will not be repeated here.

At S1003, a ground distance between each first point cloud in the set of pseudo point clouds and a ground equation is acquired based on coordinate information of each first point cloud.

At S1004, the first point cloud with a ground distance less than a preset distance threshold is removed from the set of pseudo point clouds.

With respect to blocks S1003 to S1004, description has been made in the above embodiments, which will not be repeated here.

At S1005, a set of candidate point clouds is generated by splicing the set of real point clouds and the set of pseudo point clouds.

At S1006, coordinate information of each second point cloud is acquired, and coordinate information of a center point of the set of real point clouds is acquired.

At S1007, the Euclidean distance is determined based on the coordinate information of the first point cloud and the coordinate information of the center point.

At S1008, a retention probability of the first point cloud is generated based on the Euclidean distance of the first point cloud.

At S1009, a preconfigured retention probability of the second point cloud is acquired.

At S1010, a set of target point clouds is obtained by performing random down-sampling on the set of candidate point clouds, in which a probability used by the random down-sampling is the retention probability.

With respect to blocks S1005 to S1010, description has been made in the above embodiments, which will not be repeated here.

At S1011, a trained 3D target detection model is generated by training a constructed 3D target detection model using the set of target point clouds.

A method for generating point cloud data is provided in the embodiment of the disclosure. A set of real point clouds for a target object is acquired based on a LiDAR; image acquisition is performed by an apparatus for acquiring an image on the target object, and a set of pseudo point clouds is generated based on an acquired image; and a set of target point clouds for model training is generated by fusing the set of real point clouds and the set of pseudo point clouds. In the disclosure, near and far point clouds in the set of target point clouds for model training are relatively balanced, which may satisfy training requirements better, thus facilitating providing a training precision of a model and monitoring near and far targets.

Each embodiment of the disclosure may be executed separately or in combination with other embodiments, which should be deemed within a protection scope of the disclosure.

FIG. 11 is a block diagram illustrating an apparatus 1100 for generating point cloud data according to an embodiment of the disclosure. As illustrated in FIG. 11, the apparatus 1100 for generating point cloud data includes a real point cloud set acquiring module 1101, a pseudo point cloud set acquiring module 1102 and a point cloud set fusing module 1103.

The real point cloud set acquiring module 1101 is configured to acquire a set of real point clouds for a target object based on a LIDAR.

The pseudo point cloud set acquiring module 1102 is configured to perform image acquisition on the target object, and generate a set of pseudo point clouds based on an acquired image.

The point cloud set fusing module 1103 is configured to generate a set of target point clouds for model training by fusing the set of real point clouds and the set of pseudo point clouds.

It needs to be noted that the foregoing explanation of the embodiments of the method for generating point cloud data is also applied to the apparatus for generating point cloud data in the embodiment, which will not be repeated here.

An apparatus for generating point cloud data is provided in the embodiment of the disclosure. A set of real point clouds for a target object is acquired based on a LIDAR; image acquisition is performed by an apparatus for acquiring an image on the target object, and a set of pseudo point clouds is generated based on an acquired image; and a set of target point clouds for model training is generated by fusing the set of real point clouds and the set of pseudo point clouds. In the disclosure, near and far point clouds in a set of target point clouds for model training are relatively balanced, which may satisfy training requirements better, thus facilitating providing a training precision of a model and monitoring near and far targets.

Further, in one possible implementation of the embodiment of the disclosure, the point cloud set fusing module 1103 is specifically configured to: acquire a ground distance between each first point cloud in the set of pseudo point clouds and a ground equation based on coordinate information of each first point cloud; and remove the first point cloud with the ground distance less than a preset distance threshold from the set of pseudo point clouds.

Further, in one possible implementation of the embodiment of the disclosure, the point cloud set fusing module 1103 is further configured to: generate a set of candidate point clouds by splicing the set of real point clouds and the set of pseudo point clouds; acquire an Euclidean distance between each first point cloud in the set of pseudo point clouds and the set of real point clouds based on coordinate information of each first point cloud and coordinate information of each second point cloud in the set of real point clouds; and generate the set of target point clouds by selecting point clouds from the set of candidate point clouds based on the Euclidean distance of each first point cloud.

Further, in one possible implementation of the embodiment of the disclosure, the point cloud set fusing module 1103 is further configured to: generate a retention probability of each first point cloud based on the Euclidean distance of each first point cloud; acquire a preconfigured retention probability of the second point cloud; and obtain the set of target point clouds by performing random down-sampling on the set of candidate point clouds, a probability used by the random down-sampling is the retention probability.

Further, in one possible implementation of the embodiment of the disclosure, the point cloud set fusing module 1103 is further configured to: acquire the coordinate information of each second point cloud, and acquire coordinate information of a center point of the set of real point clouds; and determine the Euclidean distance based on the coordinate information of the first point cloud and the coordinate information of the center point.

Further, in one possible implementation of the embodiment of the disclosure, the apparatus 1100 for generating point cloud data further includes a model training module 1104 configured to generate a trained 3D target detection model by training a constructed 3D target detection model using the set of target point clouds.

In the embodiment of the present disclosure, an electronic device, a readable storage medium and a computer program product are further provided according to embodiments of the present disclosure

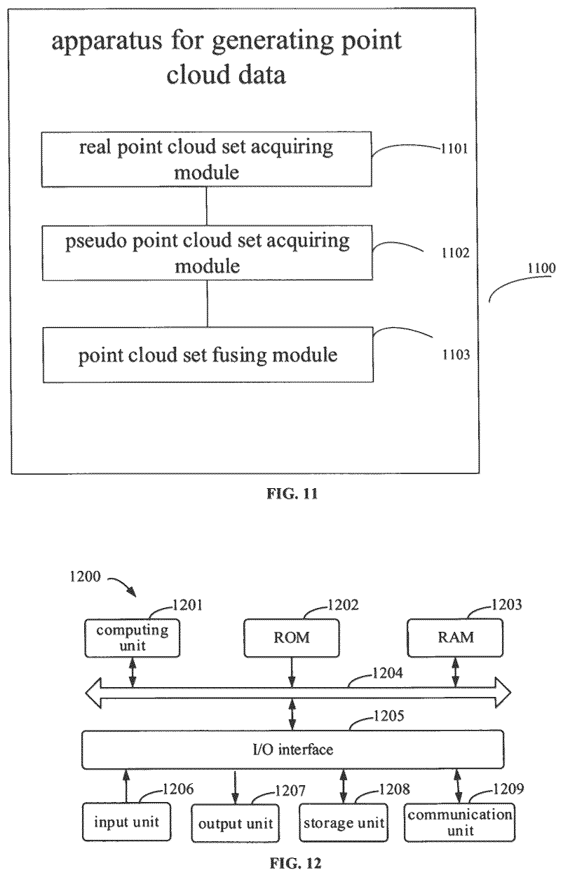

FIG. 12 is a block diagram illustrating an electronic device 1200 in an embodiment of the present disclosure. The electronic device is intended to represent various types of digital computers, such as laptop computers, desktop computers, workstations, personal digital assistants, servers, blade servers, mainframe computers, and other suitable computers. The electronic device may also represent various types of mobile apparatuses, such as personal digital assistants, cellular phones, smart phones, wearable devices, and other similar computing devices. The components shown herein, their connections and relations, and their functions are merely examples, and are not intended to limit the implementation of the disclosure described and/or required herein.

As illustrated in FIG. 12, the device 1200 includes a computing unit 1201, configured to execute various appropriate actions and processes according to a computer program stored in a read-only memory (ROM) 1202 or loaded from a storage unit 1208 to a random access memory (RAM) 1203. In the RAM 1203, various programs and data required for the device 1200 may be stored. The computing unit 1201 the ROM 1202 and the RAM 1203 may be connected with each other by a bus 1204. An input/output (I/O) interface 1205 is also connected to the bus 1204.

A plurality of components in the device 1200 are connected to an I/O interface 1205, and includes: an input unit 1206, for example, a keyboard, a mouse, etc.; an output unit 1207, for example various types of displays, speakers; the storage unit 1208, for example a magnetic disk, an optical disk; and a communication unit 1209, for example, a network card, a modem, a wireless transceiver. The communication unit 1209 allows the device 1200 to exchange information/data through a computer network such as internet and/or various types of telecommunication networks and other devices.

The computing unit 1201 may be various types of general and/or dedicated processing components with processing and computing ability. Some examples of the computing unit 1201 include but not limited to a central processing unit (CPU), a graphics processing unit (GPU), various dedicated artificial intelligence (AI) computing chips, various computing units running a machine learning model algorithm, a digital signal processor (DSP), and any appropriate processor, controller, microcontroller, etc. The computing unit 1201 executes various methods and processes as described above, for example, a method for generating point cloud data. For example, in some embodiments, the method for generating point cloud data may be further implemented as a computer software program, which is physically contained in a machine readable medium, such as the storage unit 1208. In some embodiments, a part or all of the computer program may be loaded and/or installed on the device 1200 through the ROM 1202 and/or the communication unit 1209. When the computer program is loaded on the RAM 1203 and executed by the computing unit 1201, one or more blocks in the method for generating point cloud data as described above may be performed. Alternatively, in other embodiments, the computing unit 1201 may be configured to perform the method for generating point cloud data in other appropriate ways (for example, by virtue of a firmware).

Various implementation modes of systems and technologies described herein may be implemented in a digital electronic circuit system, an integrated circuit system, a field programmable gate array (FPGA), a dedicated application specific integrated circuit (ASIC), a system on a chip (SoC), a load programmable logic device (CPLD), a computer hardware, a firmware, a software, and/or combinations thereof. The various implementation modes may include: being implemented in one or more computer programs, and the one or more computer programs may be executed and/or interpreted on a programmable system including at least one programmable processor, and the programmable processor may be a dedicated or a general-purpose programmable processor that may receive data and instructions from a storage system, at least one input apparatus, and at least one output apparatus, and transmit the data and instructions to the storage system, the at least one input apparatus, and the at least one output apparatus.

A computer code configured to execute a method in the present disclosure may be written with one or any combination of multiple programming languages. These programming languages may be provided to a processor or a controller of a general purpose computer, a dedicated computer, or other apparatuses for programmable data processing so that the function/operation specified in the flowchart and/or block diagram may be performed when the program code is executed by the processor or controller. A computer code may be executed completely or partly on the machine, executed partly on the machine as an independent software package and executed partly or completely on the remote machine or server.

In the context of the present disclosure, a machine-readable medium may be a tangible medium that may contain or store a program intended for use in or in conjunction with an instruction execution system, apparatus, or device. A machine-readable medium may be a machine readable signal medium or a machine readable storage medium. A machine readable storage medium may include but not limited to an electronic, magnetic, optical, electromagnetic, infrared, or semiconductor system, apparatus or device, or any appropriate combination thereof. A more specific example of a machine readable storage medium includes an electronic connector with one or more cables, a portable computer disk, a hardware, a random access memory (RAM), a read-only memory (ROM), an EPROM programmable read-only ROM (an EPROM or a flash memory), an optical fiber device, and a portable optical disk read-only memory (CDROM), an optical storage device, a magnetic storage device, or any appropriate combination of the above.

In order to provide interaction with the user, the systems and technologies described here may be implemented on a computer, and the computer has: a display apparatus for displaying information to the user (for example, a CRT (cathode ray tube) or a LCD (liquid crystal display) monitor); and a keyboard and a pointing apparatus (for example, a mouse or a trackball) through which the user may provide input to the computer. Other types of apparatuses may further be configured to provide interaction with the user; for example, the feedback provided to the user may be any form of sensory feedback (for example, visual feedback, auditory feedback, or tactile feedback); and input from the user may be received in any form (including an acoustic input, a speech input, or a tactile input).

The systems and technologies described herein may be implemented in a computing system including back-end components (for example, as a data server), or a computing system including middleware components (for example, an application server), or a computing system including front-end components (for example, a user computer with a graphical user interface or a web browser through which the user may interact with the implementation mode of the system and technology described herein), or a computing system including any combination of such back-end components, middleware components or front-end components. The system components may be connected to each other through any form or medium of digital data communication (for example, a communication network). Examples of communication networks include: a local area network (LAN), a wide area network (WAN), an internet and a blockchain network.

The computer system may include a client and a server. The client and server are generally far away from each other and generally interact with each other through a communication network. The relation between the client and the server is generated by computer programs that run on the corresponding computer and have a client-server relationship with each other. A server may be a cloud server, also known as a cloud computing server or a cloud host, is a host product in a cloud computing service system, to solve the shortcomings of large management difficulty and weak business expansibility existed in the traditional physical host and Virtual Private Server (VPS) service. A server further may be a server with a distributed system, or a server in combination with a blockchain.

It should be understood that, various forms of procedures shown above may be configured to reorder, add or delete blocks. For example, blocks described in the present disclosure may be executed in parallel, sequentially, or in a different order, as long as the desired result of the technical solution disclosed in the present disclosure may be achieved, which will not be limited herein.

The above specific implementations do not constitute a limitation on the protection scope of the present disclosure. Those skilled in the art should understand that various modifications, combinations, sub-combinations and substitutions may be made according to design requirements and other factors. Any modification, equivalent replacement, improvement, etc., made within the spirit and principle of embodiments of the present disclosure shall be included within the protection scope of embodiments of the present disclosure.

1. A method for generating point cloud data, comprising:
acquiring a set of real point clouds for a target object based on a LIDAR;
generating a set of pseudo point clouds based on an image of the target object; and
generating a set of target point clouds for model training by fusing the set of real point clouds and the set of pseudo point clouds.

2. The method of claim 1, wherein, generating the set of target point clouds for model training by fusing the set of real point clouds and the set of pseudo point clouds further comprises:
acquiring a ground distance between each first point cloud in the set of pseudo point clouds and a ground equation based on coordinate information of each first point cloud; and
removing the first point cloud with the ground distance less than a preset distance threshold from the set of pseudo point clouds.

3. The method of claim 1, wherein, generating the set of target point clouds for model training by fusing the set of real point clouds and the set of pseudo point clouds further comprises:
generating a set of candidate point clouds by splicing the set of real point clouds and the set of pseudo point clouds;
acquiring an Euclidean distance between each first point cloud in the set of pseudo point clouds and the set of real point clouds based on coordinate information of each first point cloud and coordinate information of each second point cloud in the set of real point clouds; and
generating the set of target point clouds by selecting point clouds from the set of candidate point clouds based on the Euclidean distance of each first point cloud.

4. The method of claim 3, wherein, generating the set of target point clouds by selecting point clouds from the set of candidate point clouds based on the Euclidean distance of each first point cloud comprises:
generating a retention probability of each first point cloud based on the Euclidean distance of each first point cloud;
acquiring a preconfigured retention probability of the second point cloud; and
obtaining the set of target point clouds by performing random down-sampling on the set of candidate point clouds based on the retention probability of each first point cloud and the preconfigured retention probability of the second point cloud.

5. The method of claim 3, wherein, acquiring the Euclidean distance between each first point cloud in the set of pseudo point clouds and the set of real point clouds based on the coordinate information of each first point cloud and the coordinate information of each second point cloud in the set of real point clouds, comprises:
acquiring coordinate information of a center point of the set of real point clouds based on the coordinate information of each second point cloud; and
determining the Euclidean distance based on the coordinate information of the first point cloud and the coordinate information of the center point.

6. The method of claim 1, wherein, generating the set of target point clouds for model training further comprises:
generating a trained 3D target detection model by training a constructed 3D target detection model using the set of target point clouds.

7-12. (canceled)

13. An electronic device, comprising:
at least one processor; and
a memory communicatively connected to the at least one processor and stored with instructions executable by the at least one processor,
wherein when the instructions are performed by the at least one processor, the at least one processor is caused to perform the following:
acquiring a set of real point clouds for a target object based on a LIDAR;
generating a set of pseudo point clouds based on an image of the target object; and
generating a set of target point clouds for model training by fusing the set of real point clouds and the set of pseudo point clouds.

14. A non-transitory computer-readable storage medium having computer instructions stored thereon, wherein the computer instructions are configured to cause a computer to perform the following:
acquiring a set of real point clouds for a target object based on a LIDAR;
generating a set of pseudo point clouds based on an image of the target object; and
generating a set of target point clouds for model training by fusing the set of real point clouds and the set of pseudo point clouds.

15. (canceled)

16. The method of claim 1, further comprising:
performing image acquisition on the target object to obtain the image of the target object.

17. The method of claim 2, wherein, generating the set of target point clouds for model training by fusing the set of real point clouds and the set of pseudo point clouds further comprises:
generating a set of candidate point clouds by splicing the set of real point clouds and the set of pseudo point clouds;
acquiring an Euclidean distance between each first point cloud in the set of pseudo point clouds and the set of real point clouds based on coordinate information of each first point cloud and coordinate information of each second point cloud in the set of real point clouds; and
generating the set of target point clouds by selecting point clouds from the set of candidate point clouds based on the Euclidean distance of each first point cloud.

18. The electronic device of claim 13, wherein, generating the set of target point clouds for model training by fusing the set of real point clouds and the set of pseudo point clouds further comprises:
acquiring a ground distance between each first point cloud in the set of pseudo point clouds and a ground equation based on coordinate information of each first point cloud; and
removing the first point cloud with the ground distance less than a preset distance threshold from the set of pseudo point clouds.

19. The electronic device of claim 13, wherein, generating the set of target point clouds for model training by fusing the set of real point clouds and the set of pseudo point clouds further comprises:
generating a set of candidate point clouds by splicing the set of real point clouds and the set of pseudo point clouds;
acquiring an Euclidean distance between each first point cloud in the set of pseudo point clouds and the set of real point clouds based on coordinate information of each first point cloud and coordinate information of each second point cloud in the set of real point clouds; and
generating the set of target point clouds by selecting point clouds from the set of candidate point clouds based on the Euclidean distance of each first point cloud.

20. The electronic device of claim 19, wherein, generating the set of target point clouds by selecting point clouds from the set of candidate point clouds based on the Euclidean distance of each first point cloud comprises:
generating a retention probability of each first point cloud based on the Euclidean distance of each first point cloud;
acquiring a preconfigured retention probability of the second point cloud; and
obtaining the set of target point clouds by performing random down-sampling on the set of candidate point clouds based on the retention probability of each first point cloud and the preconfigured retention probability of the second point cloud.

21. The electronic device of claim 19, wherein, acquiring the Euclidean distance between each first point cloud in the set of pseudo point clouds and the set of real point clouds based on the coordinate information of each first point cloud and the coordinate information of each second point cloud in the set of real point clouds, comprises:
acquiring coordinate information of a center point of the set of real point clouds based on the coordinate information of each second point cloud; and
determining the Euclidean distance based on the coordinate information of the first point cloud and the coordinate information of the center point.

22. The electronic device of claim 13, wherein, generating the set of target point clouds for model training further comprises:
generating a trained 3D target detection model by training a constructed 3D target detection model using the set of target point clouds.

23. The storage medium of claim 14, wherein, generating the set of target point clouds for model training by fusing the set of real point clouds and the set of pseudo point clouds further comprises:
acquiring a ground distance between each first point cloud in the set of pseudo point clouds and a ground equation based on coordinate information of each first point cloud; and
removing the first point cloud with the ground distance less than a preset distance threshold from the set of pseudo point clouds.

24. The storage medium of claim 14, wherein, generating the set of target point clouds for model training by fusing the set of real point clouds and the set of pseudo point clouds further comprises:
generating a set of candidate point clouds by splicing the set of real point clouds and the set of pseudo point clouds;
acquiring an Euclidean distance between each first point cloud in the set of pseudo point clouds and the set of real point clouds based on coordinate information of each first point cloud and coordinate information of each second point cloud in the set of real point clouds; and
generating the set of target point clouds by selecting point clouds from the set of candidate point clouds based on the Euclidean distance of each first point cloud.

25. The storage medium of claim 24, wherein, generating the set of target point clouds by selecting point clouds from the set of candidate point clouds based on the Euclidean distance of each first point cloud comprises:
generating a retention probability of each first point cloud based on the Euclidean distance of each first point cloud;
acquiring a preconfigured retention probability of the second point cloud; and
obtaining the set of target point clouds by performing random down-sampling on the set of candidate point clouds based on the retention probability of each first point cloud and the preconfigured retention probability of the second point cloud.

26. The storage medium of claim 24, wherein, acquiring the Euclidean distance between each first point cloud in the set of pseudo point clouds and the set of real point clouds based on the coordinate information of each first point cloud and the coordinate information of each second point cloud in the set of real point clouds, comprises:
acquiring coordinate information of a center point of the set of real point clouds based on the coordinate information of each second point cloud; and
determining the Euclidean distance based on the coordinate information of the first point cloud and the coordinate information of the center point.

27. The storage medium of claim 14, wherein, generating the set of target point clouds for model training further comprises:
generating a trained 3D target detection model by training a constructed 3D target detection model using the set of target point clouds.
